(19) United States
(12) Patent Application Publication
(10) Pub. No.: US 2003/0145763 A1
(43) Pub. Date: Aug. 7, 2003

(54) Flocculant or binder composition, slurry containing the flocculant or binder composition, method for making ceramics using the slurry, and ceramic products made therefrom

(76) Inventors: Dietmar Grull, Langenschonbichl (AT); Marnik Michel Wastyn, Schwechat (AT); Martin Kozich, Wien (AT)

Correspondence Address: LERNER AND GREENBERG, P.A., Post Office Box 2480, Hollywood, FL, 33022-2480, US

(21) Appl. No.: 10/371,135

(22) Filed: Feb. 21, 2003

Related U.S. Application Data
(63) Continuation of application No. PCT/AT01/00260, filed on Aug. 1, 2001.

(30) Foreign Application Priority Data
Aug. 21, 2000 (AT) A 1435/2000

(51) Int. Cl. C08L 3/00; C04B 35/18; C09J 103/00; C09D 103/00

(52) U.S. Cl. 106/206.1; 501/95.1; 106/214.1

(57) ABSTRACT

A flocculant or binder composition can be used to form a slurry, which in turn, is usable in methods of producing ceramics and ceramic products. The flocculant or binder composition includes amylopectin potato starch (AP-PS).

### CROSS-REFERENCE TO RELATED APPLICATION

This application is a continuation of copending International Application No. PCT/AT01/00260, filed Aug. 1, 2001, which designated the United States and was not published in English.

### BACKGROUND OF THE INVENTION

### Field of the Invention

the invention relates to a flocculant or binder composition, a slurry containing the flocculant or binder composition, a method for making ceramics using the slurry, and ceramic products made therefrom.

When producing ceramics products, inorganic base materials that are mostly inorganic fiber materials are introduced into an aqueous sludge referred to as a slurry. The addition of flocculants and/or binders, and optionally other components, will cause the formation of flocks. After the separation of the formed flocks, the moist cake is at first dried and then baked into ceramics using different thermal processes.

In order to prepare suitable slurries, a great number of additives are required, including flocculants and/or binders, by which the inorganic materials contained in the slurry are brought into a form/distribution that is suitable for the final heat treatment.

Due to the increasing concern for environmental protection of the last decade, there has been great interest in using, for the manufacture of ceramics, flocculants and/or binders that do not produce environmentally relevant noxious matter during the final heat treatment, which is also called carbonization if inorganic substances are used. Aromatic compounds such as, for instance, phenolic resins were frequently used in former times, as in German published, non-prosecuted patent application DE 32 31 100 A1, for the production of shaped articles of silicon carbide. Starch-containing products have recently been successfully employed for that purpose.

Therefore, flocculants and binders based on starch have been widely applied on the ceramics sector. This is of special importance, because flocculants and binders based on starch are of natural origin and hence more environment-friendly. Thus, no hazardous substances that might have impacts on the environment are released during carbonization.

Thus, the use of potato, corn and wheat starch derivatives is described in U.S. Pat. No. 5,618,767, which indicates the merits of starch during carbonization. In particular, this patent describes the use of the above-mentioned starches in the manufacture of ceramics products based on silicon carbide.

U.S. Pat. No. 3,224,927 deals extensively with the potentialities of cationic starches in the manufacture of heat-resistant products. This patent emphasizes the advantages of those starch products and their optimal integration into a system of fibers and the binder silica sol. The starches described include commercially available cationic starches from National Starch, which have to be initially gelatinized during flocculation.

International PCT publication WO 99/15322 describes the vacuum-forming process technique for the production of ceramic shaped bodies. In that process, flocculants are preferably added, with cold-water soluble cationic starches being above all applied. Commercially available products based on cornstarch or conventional potato starch are emphasized.

European Patent Application EP-094 731 A teaches the production of shaped ceramics. This application also teaches binders made from starch and, in particular, corn starch and also rice starch, tapioca starch, and conventional potato starch.

In the prior art described, starch products are, thus, used as flocculants or binders in native, degraded, modified, and derivatized forms.

Starch is a natural plant product. It essentially includes a glucose polymer that, as a rule, is a composition of two components, namely amylopectin and amylose. These are, in turn, not uniform substances, but mixtures of polymers having different molecular weights. Amylose essentially includes unbranched polysaccharides in which glucose is present in an alpha-1,4-bond. Amylopectin, on the other hand, is a strongly branched glucose polymer in which the glucose moieties on the branching points are contained in 1,6-bonds in addition to alpha-1,4-bonds.

Natural starches, as a rule, have amylose contents ranging from 15 to 30%; only corn varieties of the waxy type yield starches that are formed almost exclusively of amylopectin. The field of application of this starch, which is called waxy corn starch, primarily pertains to the food industry. There, it is particularly appreciated that amylose-free starch tends to threading during gelatinization to a largely less extent, thus giving a more pleasant mouthfeel. In addition, amylopectin starch exhibits fewer retrogradation phenomena, i.e. tends less strongly to reunifying already separated chains, than starch rich in amylose.

The cultivation of waxy corn is hardly practical or possible from an economical point of view in cold or tempered climes that are found in Austria, Germany, Belgium, the Netherlands, Great Britain, Poland, etc. Therefore, waxy corn could not find acceptance in those areas for cost reasons. By contrast, potatoes are common starch sources in those countries. Compared to cereal starch, potato starch has a lower content of lipids and proteins and contains considerable amounts of phosphate ester groups. A comparative representation in this respect, which takes into account the amylopectin potato starch presently claimed, is set out in the experimental part of the description of the present invention.

Methods for reducing the amylose content of starch by physical or chemical methods are known. Yet, these involve considerable expenditures and are feasible only when justified from an economical point of view.

These methods for reducing amylose contents, however, require treatments at elevated temperatures (usually above approximately 140° C.), which will inevitably result in the formation of degradation products. Yet, such degradation products may have adverse effects with many applications. Moreover, the fractionation process is very complex and cost-intensive; this has so far prevented such products from being successful in large-scale applications. In the context of the present invention, amylopectin potato starches prepared by fractionation are referred to as fractionated amylopectin potato starches (FAP-PSs).

Due to the successful genetic modification of potatoes achieved during the last decade, which was aimed at providing a starch free of amylose, completely new types of starch could be made accessible (See international PCT publication WO 92/11376 A). As a result, it became, for instance, feasible for the first time to obtain an amylose-poor or amylose-free potato starch in which the three-dimensional amylopectin structure typical of potato starch is completely retained without involving the formation of degradation products or deviations of the three-dimensional network from the native structure (cf. international PCT publication WO 92/11376). In this manner, an amylopectin potato starch is provided, which is not only substantially more defined, but also particularly well apt for derivatization processes (cf. again international PCT publication WO 92/11376 A).

Although a plurality of applications have been proposed for these novel starch products, only little is known about the actual technical exploitability of these starch products on account of the small amounts available so far. Thus, waxy cornstarch is still the only starch product rich in amylopectin that has so far been used on an industrial scale in the prior art. Waxy cornstarch has already gained ground on the market because of its ready availability as compared to FAP-PS or other waxy cereal starches that can be obtained from mutants of common cultigens.

The above-mentioned amylopectin-rich starches with native amylopectin patterns (cf. international PCT publication WO 92/11376) have already been proposed for some applications as pointed out above, yet not for the manufacture of ceramics products. These starches are produced by selectively manipulating the amylose-forming enzymes contained in the potato and are referred to as amylopectin potato starches (AP-PS) for the purposes of the present invention.

### SUMMARY OF THE INVENTION

It is accordingly an object of the invention to provide a flocculant or binder composition, a slurry containing the flocculant or binder composition, a method for making ceramics using the slurry, and ceramic products made therefrom that overcome the hereinafore-mentioned disadvantages of the heretofore-known devices of this general type by providing a flocculant or binder composition that includes amylopectin potato starch (AP-PS).

In the production of ceramics products, amylopectin potato starch surprisingly exhibited properties substantially superior to those of products proposed so far for this purpose and, in particular, in comparison with other starch products. In the context of the present invention, it was, in fact, possible to achieve a decisive improvement particularly over fractionated amylopectin potato starch (FAP-PS) as well as over waxy corn starch and, of course, also over conventional potato starch as well as over products derived from these starch derivatives.

Amylopectin-rich starch has so far been proposed only for applications in fields where its properties have come to light at room temperature or at slightly elevated temperatures such as, for instance, in the textile and paper industries (cf., e.g., U.S. Pat. No. 5,582,670). However, in the ceramics sector, the use of AP-PS in the course of production processes has neither been proposed nor encouraged. Accordingly, the completely surprising positive properties of AP-PS as against related products and, in particular, other starches rich in amylopectin such as FAP-PS or waxy corn starch, also have not yet been revealed.

By the term “ceramics”, products made of clay minerals are understood both in everyday usage and according to the invention. The diversity of ceramic materials, as well as their applications, have largely increased during the past decades such that, in addition to clay minerals, also carbides, nitrides, oxides, or silicides are used today amongst others. Concurrently with this development, refractory ceramics became established on the market. According to DIN 51060, the term refractory materials serves to denote nonmetallic materials like high-melting oxides, refractory silicates, etc. (yet including those containing defined metal portions like, for instance, cermets), which have Seger cone falling points of at last 1500° C. These products stand out for being usable at temperatures exceeding 800° C. over extended periods of time.

According to the ISO recommendation R 1109, they are classified as follows:

1. Products rich in alumina group 1: >56% Al₂O₃

2. Products rich in alumina group 2: 45-56% Al₂O₃

3. Fireclay refractories: 30-45% Al₂O₃

4. Acidic fireclay refractories: 10-30% Al₂O₃, <85% SiO₂

5. Siliceous refractories: 85-93% SiO₂

6. Silica products: >93% SiO₂

7. Basic refractories: with variable amounts of magnesite-chromite

8. Special products based on carbon, graphite, Zi-silicate, nitrides, borides, cermets

Ceramics products offer a large and wide field of application. Typical examples include their use in the car industry, in industrial blast furnaces for refractory materials, or high-temperature filters.

Ceramics products are above all characterized by their porosity. The porosity is achieved especially by using starch-containing flocculants or binders.

Although, in principle, starch has been used as a flocculant in other fields (for instance in paper production), the ceramics industry makes very special demands on a flocculant. On the one hand, the demands are attributed to the preparation of slurries of inorganic materials. On the other hand, the demands are explained by the drying/forming and firing processes following subsequently.

“Flocculant” is meant to include those substances that influence the zeta potential (electrokinetic potential) of colloidal particles to cause the formation of aggregates, such as, for instance, flocks. The zeta potential of dispersed particles is reduced or neutralized by flocculants. In order to enable flocculation at all, the flocculant must overcome the electrostatic repulsion of the particles that are mostly negatively charged in the solvent, primarily water.

Starches or starch derivatives cause solids particles to agglomerate to large units (flocks). Bridging causes the agglomeration to suspended particles. According to accepted teachings, the effectiveness of a flocculant is a function of the ionic character, on the one hand, and of the molecular chain length, on the other hand. It has not yet been recognized that the nativity of the amylopectin structure might play an important role in this respect. Moreover, starch may also have a binding function in the field of ceramics products. It may, for instance, constitute an important binding link between fibers and other auxiliary substances or binders like silica sol. On account of its organic nature, starch is a temporary binder that is converted into carbon by heat treatment, thus forming a stable three-dimensional network structure (porous matrix) with the silicon present.

It has been shown by the invention that it is exactly AP-PS that imparts special properties on the produced ceramics product by that conversion. Then there are the properties that are enhanced during the preparation process of the slurry.

AP-PS is preferably obtained from potatoes in which the starch granule-bound starch synthase I (GBSS I), which is responsible for the -1,4-glycosidic bond to the linear amylose molecule, is limited in its activity or totally inactivated, for instance by a suitable antisense technology as described in international PCT publication WO 92/11376. The inhibition of GBSS I, for instance, allows for the production from potatoes, of native AP-PS with an amylopectin content that is largely increased as compared to that of natural potato starch, without having to put up with the disadvantage of fractionated amylopectin potato starch (degradation products; thermal treatment).

Therefore, AP-PS having a content of at least 95%, preferably at least 98%, of amylopectin, based on the overall starch quantity, is used in a preferred manner.

Preferably, AP-PS is obtained from a potato modified by breeding or by molecular-biological or genetic-engineering techniques for the purpose of amylose inhibition. Above all, the AP-PS to be used according to the invention is obtained from a potato inhibited by the antisense inhibition of a GBSS gene or by co-suppression in respect to amylose formation. In doing so, the synthesis of amylose is preferably impeded or inhibited, with the amylopectin branching being preferably left unchanged. After all, this is readily feasible from a technical point of view, since the synthesis of amylose and the formation of amylopectin branching patterns are two completely independent processes occurring in the plant. The participating enzymes are specific for both processes and can each be influenced in their activities in a mutually independent and specific manner, for instance by genetic-engineering interventions. Thus, AP-PS can be obtained as a known starch (potato starch) with a modified amylose/amylopectin ratio at an otherwise completely unchanged quality (regarding its branching degree). As opposed to the preparation of FAP-PS, the starch quality in recombinantly produced AP-PS is unambiguously definable and hence accessible to a precise success control, whereby the industrial availability of AP-PS is safeguarded.

Starches obtained from genetically manipulated potatoes in which the branching degree of amylopectin has been modified (optionally at an equally high portion of amylose; see international PCT publication WO 96/19581) turned out to be disadvantageous in the context of the present invention and, therefore, are not to be considered as AP-PSs in the sense of the present invention—because of their high amylose contents alone.

Other important characteristics of amylopectin potato starch are its molar mass distribution and its mean molecular weight.

The differences from waxy starches such as, for instance, waxy corn starch, or a potato starch amylopectin prepared by physical or chemical methods, become particularly apparent by size exclusion chromatography (SEC) measurements. The respective data are set out in the experimental part.

AP-PS in the flocculant or binder composition according to the invention is preferably modified and, in particular, cationically modified. In this context, amylopectin potato starches including nitrogen-containing groups and, in particular, electropositively charged quaternary ammonium groups, have proved particularly beneficial.

According to a particularly preferred embodiment, the amylopectin potato starch according to the invention is an amylopectin potato starch sulfamate.

Depending on the nature of the organic fibers used, both an anionically charged amylopectin potato starch and a cationically charged amylopectin potato starch may, however, be required. In special cases, also an amphoteric amylopectin potato starch may constitute a preferred variant.

From the literature, a plurality of derivates is known, the preparation of which is readily apparent, inter alia, from “Starch: Chemistry and Technology”, R. L. Whistler, Chapters X and XVII, 1984, and from “Modified Starches: Properties and Uses”, edited by O. B. Wurzburg, Chapters 2-6 and 9-11, CRC Press, 1986. In general, distinction is made among anionic, cationic, and amphoteric starch derivates, the following derivatization options for other starch types belonging to the prior art.

Under anionic modification of amylopectin potato starch, those derivatives are summarized where the free hydroxyl groups of the starch are substituted by anionic groups. Unlike waxy cornstarch, amylopectin potato starch includes naturally bound anionic groups such that, in the true sense, one has to speak of an additional anioinic modification. These are naturally chemically bound phosphate groups that impart an additional specific polyelectrolytic property on the amylopectin potato starch.

Basically, there are two ways of carrying out anionic derivatization:

a) Modification is effected in a manner so as to induce the esterification of amylopectin potato starch. Modification agents include inorganic or organic heterovalent, mostly bivalent, acids or salts thereof or esters or anhydrides thereof. Thus, the following acids are suitable amongst others, their enumeration being only exemplary: o-phosphoric acid, m-phosphoric acid, poly-phosphoric acid, various sulfuric acids, various silicic acids, various boric acids, oxalic acid, succinic acid, glutaric acid, adipic acid, phthalic acid, citric acid, etc. Mixed esters or anhydrides may be used as well. When esterifying amylopectin potato starch, this may also be effected several times so as to produce, for instance, distarch phosphoric esters.

b) Modification is effected in a manner so as to induce the etherification of amylopectin potato starch. Modification agents include inorganic or organic—substituted acids or salts thereof or esters thereof. This type of reaction results in the cleavage of the—substituent while forming an ether group.

Consequently, the amylopectin potato starch is additionally substituted, for instance, by phosphate, sulfate, sulfonate, or carboxyl groups. This is accomplished, for instance, by the reaction of amylopectin potato starch with—halocarbonic acid, chlorohydroxy alkyl sulfonates, or chlorohydroxy alkyl phosphonates.

Under cationic modification of amylopectin potato starch, those derivates are summarized where a positive charge is introduced into the starch by substitution. Cationization methods are carried out by the aid of amino, imino, ammonium, sulfonium, or phosphonium groups. Methods for preparing cationized starches are, for instance, described in D. B. Solareck: Cationic Starches, in the book by O. B. Wurzburg (Ed.): Modified Starches: Properties and Uses, CRC Press Inc., Boca Raton, Fla. (1986), pp 113-130. Such cationic derivatives preferably contain nitrogen-containing groups, in particular primary, secondary, tertiary, and quaternary amines, or sulfonium and phosphonium compounds, respectively, which are bound via ether or ester bonds. The use of cationized amylopectin potato starches containing electropositively charged quaternary ammonium groups is preferred.

In detail, also the sulfamates of amylopectin potato starch are to be mentioned herein, their production likewise falling within the scope of the present invention. This new amylopectin potato starch derivative is obtained by reaction of the presently claimed amylopectin potato starch with ammonium, earth alkali, or alkali sulfamates. An exemplary description of the preparation of this derivative will also be found in the experimental part.

Another group is represented by amphoteric starches. They contain both anionic and cationic groups, their applications thus being highly specific. These are usually cationic starches that are additionally modified either by phosphate groups or by xanthates. The preparation of such products is also described by D. B. Solareck: Cationic Starches, in the book by O. B. Wurzburg (Ed.): Modified Starches: Properties and Uses, CRC Press Inc., Boca Raton, Fla. (1986), pp 113-130.

Esters and ethers of amylopectin potato starch are of great importance. Distinction is made between simple starch esters and mixed starch esters, with different ester substituent(s) being conceivable: in the ester residue RCOO—, the residue R may be an alkyl, aryl, alkenyl, alkaryl, or aralkyl residue having 1 to 17 carbon atoms, preferably 1 to 6 carbon atoms and, in particular, 1 or 2 carbon atoms. These products include the following derivatives: acetates (prepared from vinyl acetate or acetic anhydride), propionates, butyrates, stearates, phthalates, succinates, oleates, maleinates, fumarates, and benzoates.

Etherifications are mainly realized by reactions with alkylene oxides containing 2 to 6 carbon atoms, preferably 2 to 4 carbon atoms and, in particular, by using ethylene and propylene oxides. Yet, also methyl, carboxymethyl, cyanoethyl, and carbamoyl ethers may be prepared and used. Further products include alkyl hydroxyalkyl, alkyl carboxyalkyl, hydroxyalkyl carboxymethyl, and alkyl hydroxy alkyl carboxymethyl derivatives.

Besides said esters and ethers, amylopectin potato starch can also be crosslinked to different extents. Crosslinking is preferably effected by reaction with a crosslinker such as epichlorohydrin or 1,3-dichloro-2-propanol, optionally mixed with (poly)amines, furthermore with phosphoroxychloride, sodium trimetaphosphate, di- or polyepoxides, mixed anhydrides of carbonic acids with di- or tribasic acids such as, for instance, a mixed anhydride of acetanhydride with adipic acid, aldehydes or aldehyde-releasing reagents such as, for instance, N,N′-dimethylol-N,N′-ethyleneurea.

Pastes of these crosslinked starches at lower degrees of crosslinking exhibit rapidly increasing viscosities which, however, decrease again with crosslinking increasing. Yet, retrogradation is very low in both cases, for which reason crosslinked amylopectin potato starch is also highly advantageous with a view to obtaining a long flocculation stability. Moreover, crosslinked amylopectin potato starches additionally modified by the compounds described above also constitute advantageous starch materials.

Finally, amylopectin potato starch may also be present as a graft polymer or a graft copolymer, for instance with products from the group of polyvinyl alcohols, acrylamides, or monomers or polymers derived from petroleum hydrocarbons. In this case, the amylopectin potato starch graft (co)polymer preferably may be present as an emulsion polymer.

All the above-mentioned modifications of amylopectin potato starch are obtainable not only by reacting native starches, but also by employing degraded forms. The degradation procedures can be realized in a mechanical, thermal, thermochemical or enzymatic manner. Thus, it is not only feasible to structurally modify amylopectin potato starch, but the starch products can also be made soluble or swellable in cold water.

Cold water soluble degraded amylopectin potato starch, in particular, can be prepared with or without pre-gelatinization by drum drying, spray drying, etc. The degree of dissociation is of great relevance to the optimum development of the properties of starch or starch derivatives soluble in cold water. Amylopectin potato starch or its derivatives do not show any lump formation, dust development and tendency to demixing during their dissociation and subsequent use and are, therefore, perfectly processable in the practical application of a suitable paste-based dry product upon stirring into water. A very special method in this context is extrusion. It offers the possibility to degrade modified amylopectin potato starch to different extents by physical action and, at the same time, convert it into a product soluble or swellable in cold water. Moreover, this technology also renders feasible the direct derivatization of amylopectin potato starch in a cost-saving manner.

When producing starch derivatives, the elevated grain stability of amylopectin potato starch allows for a simpler production technology than does conventional potato starch. The realization of reactions, for instance, in slurries is more efficient, yielding higher reaction rates. Besides, amylopectin potato starch is less sensible to alkalis and temperatures than conventional starches. Derivatization reactions like, for instance, etherification or esterification reactions, as well as many other reactions preferably used for the derivatization of starches, can thus be intensified at shorter reaction times while the use of gelatinization protection salts can be markedly reduced. The saving of reaction time and the marked reduction of chemicals employed is reflected not only economically by reduced production costs, but also in terms of ecology. Thus, for instance, the salt and CSB loads of reaction waste waters are considerably reduced.

The flocculant or binder composition according to the invention further may include sedimentation accelerators, stabilizers, dispersants, antifoaming agents, softeners, non-starch-based adhesives or adhesive precursors, buffers, salts, preserving agents or other common additives, optionally in combination. The selection and quantity of the aforementioned additives are, above all, functions of the intended use of the flocculant or binder composition, primarily in view of the inorganic fibers employed.

According to another aspect, the present invention relates to the use of AP-PS as a flocculant or binder in the production of ceramics products and the use of a flocculant or binder composition according to the invention for the production of ceramics products.

Ceramics products are generally performed according to the following method. First, an aqueous suspension of inorganic fibers is prepared. Added to the aqueous suspension is an inorganic binder, usually in the form of colloidal silica sol, as well as the starch (according to the invention, that is the amylopectin potato starch), mostly in the positively charged state. Depending on the property of the product, additives and fillers may also be added. In general, the flock-containing mixture has a pH of 4 to 8. Decanting the liquid phase through a screened shaped body separates the formed flocks. The moist cake obtained by this procedure, which is generally referred to as green body, is initially dried and then baked to ceramics after various thermal procedures such as, for instance, sintering. The aim in any event is to carbonize the starch in order to thereby impart the desired porosity on the ceramic material. A general description for the manufacture of ceramics is to be found in “Coagulation and Flocculation”, edited by Bohuslav Dobias, Chapter 11 (1993).

The slurry necessary for the production of ceramics products in most cases has a solids content of about 0.3-6% usually composed as follows (the data indicated below referring to the overall weight of the slurry):

The portion of inorganic fibers is around 0.5-4%, preferably at a concentration of 0.5-2%. In addition, organic or inorganic fillers are also added, which are usually employed at concentrations of 0-3%, preferably 0.1-2%. The binder is added in an amount of <2%, mostly <0.5%. The amylopectin potato starch is present at a concentration of from 0.001 to 0.5%, preferably 0.01 to 0.3%. Besides, up to 1% of additives such as, for instance, sedimentation accelerators, dispersants, antifoaming agents, softeners and many others may also be added, provided these additives have no adverse effects on the flocculation procedure. The large remainder in the slurry is water.

The inorganic fiber employed is of great relevance to the quality and demand of the ceramics product. The used fibers in most cases include aluminum silicates and are available on the market under various trade names. Examples of known product groups include the following fibers: Fiberfrax (available from Unifrax), Kaowool (Thermal Ceramics) or Maxsil (McAllister). Fibers made of zirconium, magnesium, calcium, yttrium, titanium, and other metals or oxides are primarily used for high-temperature applications. Yet, also whiskers or tabular oxides are used amongst others.

In the production of ceramics products, also fillers may be added. These substances preferably include oxides of aluminum or aluminum silicates, but also chalk. Moreover, organic fibers such as, for instance, celluloses or polyethylene are applied.

The flocculation process proper is then realized according to the invention by the addition of amylopectin potato starch or a derivative thereof.

Accordingly, the present invention also relates to a slurry for the production of ceramics products, which is characterized in that it includes a flocculant or binder according to the invention.

The invention preferably provides a slurry including AP-PS at a concentration of 0.001 to 0.5 weight percent.

With the objects of the invention in view, there is also provided a slurry that includes the following: inorganic fibers, in particular fibers based on aluminum silicates; fillers, in particular oxides of aluminum or aluminum silicates or chalk; organic materials, in particular organic fibers made of celluloses or polyethylene; inorganic binders, in particular colloidal silica; or mixtures of these ingredients as well as other common additives.

With the objects of the invention in view, there is also provided a method for producing ceramics products that includes the following steps: preparation of a slurry according to the invention, and thermal treatment at a temperature of above 300° C., in particular above 500° C.

A good distribution of the fibers and fillers is required for the flocculation process to proceed in the optimum manner. The addition of amylopectin potato starch, as a rule, can be accomplished in three different ways. If cooking starch is added, the slurry must be heated until boiling in order to initiate the flocculation process. It is only by heat that the starch will be gelatinized and hence brought into a water-soluble state. Alternatively, a derivative that is soluble in cold water can be introduced into the system in powdery form under moderate stirring so as to cause the amylopectin potato starch to enter into solution without lumps. A third option is to prepare a concentrated starch paste first and add it to the slurry.

It has been shown that amylopectin potato starch and, in particular, cationic amylopectin potato starch soluble in cold water, can be admixed in powdery form very quickly and, above all, free of lumps and in a completely dissolved state, what has proved to be particularly beneficial especially in the context of the present invention. The solution dynamics of amylopectin potato starch as well as the flocculation rate, in particular, could be markedly improved upon those of conventional starch derivatives. Yet, also the capacity could be substantially raised. Agglomeration or lump formation as they repeatedly occur with conventional cationic starches have not been observed at the application of amylopectin potato starch. Consequently, also possible predissolving of modified starch may be obviated, thus saving both time and equipment. It was, moreover, shown that upon introduction of the amylopectin potato starch into the system the formed flocks were extremely uniform and exhibited a markedly improved stability, particularly during extended processing times. The formed flocks surprisingly exhibit an excellent shearing stability even by the continuous agitation at an elevated speed in the reaction vessel. By using amylopectin potato starch, also inorganic fibers are wetted more effectively, thus becoming more fluid. Because of naturally chemically bound phosphate groups, amylopectin potato starch additionally offers specific polyelectrolytic properties clearly enhancing the fixation of the subsequently introduced binder on the fiber. In addition, the quantitative ratio between binder and amylopectin potato starch can be better regulated.

A further important factor resides in the clarity of the amylopectin potato starch paste, which is markedly higher. Comparative measurements with conventional cationic starch products by measuring light transmission on a conventional spectrophotometer revealed considerable advantages. Moreover, amylopectin potato starch derivative pastes show less tendency to retrogradation and are also viscostable over extended periods of time. Comparative measurements in this respect are set out in the experimental part.

In order to optimize the production of ceramics products, the addition of an inorganic binder is also favorable. In most cases, colloidal silica, which is generally referred to as silica sol, is used as an inorganic binder. As a rule, silica sols are 30-60% aqueous solutions whose turbidity is a function of the size of the SiO₂ particles contained therein. Silica sol is usually applied within a wide particle size distribution, the particle size strongly depending on the ceramics product to be produced. Silica sols are commercially available under various trade names such as MEGASOL® from

Wesbond Corporation or LUDOX® from DuPont Corporation. Silica sol is usually employed at a ratio of 3:1 to 2:1 relative to the starch. When using amylopectin potato starch, its quantity can be reduced as compared to conventional starches, thus enabling the ceramics end product to be produced at an elevated strength and lower shrinkage. Besides, any possible coagulation of the silica sol is prevented by the use of amylopectin potato starch. Alternatively, the silica sol may be replaced with a binder such as polyvinyl alcohol, polyvinyl acetate or natural or synthetic waxes, or used in combination therewith.

Various operating techniques are available for removing the flocks from the system, such as, for instance, “tape casting”, “slip casting” or “colloidal filtration” to name but a few examples. In most cases, the formed flocks are discharged into a mold by filtration or suction through pressure application. When using amylopectin potato starch, the optimum orientation of the fibers will be obtained, which is again extremely beneficial for the quality of the ceramics product. The filtrate itself is clear and free of turbid matter. It does not contain any starch residues such that this water can be repeatedly used within the production cycle without any risk. The thus produced moist cake (green body) is initially dried at about 120° C. After this, the green body is converted into a ceramics product by firing. This procedure basically occurs under slow and progressive heating so as to avoid destruction of the ceramics.

By using amylopectin potato starch, carbonization without residues can be guaranteed, which means that no toxic or environmentally damaging substances will be released. Moreover, the use of amylopectin potato starch gives rise to a particularly stable three-dimensional structure, which is also reflected in the strength values measured. Due to the fact that amylopectin potato starch exhibits an excellent solubility, which prevents the formation of agglomerated particles during the flocculation process, it is also impossible for undesired hollow spaces to form in the ceramic material during firing. Such hollow spaces would otherwise be occupied by silica, which would in turn markedly reduce the strength of the ceramics. Amylopectin potato starch, in particular, also functions as a porosity control. Due to its large hydrodynamic volume, the starch is able to develop and interact more properly. Its porosity can be readily controlled by varying inputs, thus enabling the manufacture of ceramics products having graduated product properties.

In the context of the method according to the invention, the slurry is preferably prepared through the following steps: providing an aqueous suspension of inorganic fibers; and adding an inorganic binder, in particular silica sol, and a flocculant and binder according to the invention as well as optionally further additives and fillers.

In accordance with a further object of the invention, a drying step is also provided prior to the thermal treatment step. The drying step is preferably carried out at 100 to 200° C. and, in particular, about 120 to 140° C.

The thermal treatment step preferably includes a sintering step. Preferred temperatures to be applied during the thermal treatment step as maximum temperatures range from 800 to 2500° C., preferably 1500 to 2000° C. and, in particular, are about 1800° C., which is primarily due to the nature of the inorganic fibers and the demands made on the ceramics product to be produced.

If desired, the thermal treatment step and optionally also the drying step are preceded by mechanical water removal. Likewise preferred is the provision of a forming step prior to the thermal treatment step, wherein the slurry or the green body is introduced into a suitable mold in a manner known per se.

An alternative to the direct carbonization of amylopectin potato starch resides in the manufacture of ceramically reinforced products. In this case, the green bodies produced from fibers, binder, and flocculant are penetrated with molten metal and/or metal alloys during forming without destroying the three-dimensional structure (matrix). During this procedure, the starch is baked out and a fiber-reinforced product is finally obtained. By using amylopectin potato starch, it is feasible to substantially raise the amount of porosity and to even better control the distribution. Moreover, the starch also functions perfectly as a binder between the mixed fibers and metals, which helps to further increase the stability.

In a preferred manner according to the invention, the thermal treatment step is therefore realized by the penetration of liquid metals or liquid metal alloys.

Ceramics products produced by the use of AP-PS according to the invention stand out particularly for their high strength, strong chemical and thermal resistance, excellent corrosion-resistant properties, special heat conductivity and altogether excellent overall porosity.

Accordingly, the present invention in a further aspect also relates to ceramics products that are obtainable by the production method according to the invention, i.e., by using AP-PS.

Other features that are considered as characteristic for the invention are set forth in the appended claims.

Although the invention is illustrated and described herein as embodied in a flocculant or binder for the ceramics sector, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a graph illustrating the viscosity development of different starches by plotting viscosity versus time; and

FIG. 2 is a graph comparing amylopectin potato starch with amylopectin-rich potato starch prepared by fractionation.

### DESCRIPTION OF THE PREFERRED EMBODIMENTS

### Example 1

### Preparation of Cationic Amylopectin Potato Starch

Native amylopectin potato starch is mixed into a 40% slurry. After the addition of sodium sulfate, a pH of about 11.5 is adjusted by adding 3% soda lye. Cationization is started by admixing 2,3-epoxypropyltrimethyl ammonium chloride. After 18 hours at 34° C., the reaction is stopped by neutralizing the slurry. The cationic starch was washed with water and carefully dried.

The wash-out degree of the cationic amylopectin potato starch must be very high in order to ensure that the product contains only small quantities of alkali and earth alkali traces. It is known that the elements sodium, potassium, calcium, and magnesium, but also iron and manganese, induce higher shrinkage during the carbonization of a ceramics workpiece. This effect constitutes a problem particularly with high-temperature-resistant ceramics. Consequently, the following quality demands should apply to the washing out of cationic amylopectin potato starch:

| | | | |
|---|---|---|---|
| Sodium: | <0.1% | Calcium: | <0.01% |
| Potassium: | <0.01% | Magnesium: | <0.01% |

When using amylopectin potato starch, the removal of salt loads was rapidly feasible using smaller amounts of water than with derivativse of conventional starches.

### Example 2

### Preparation of an Amylopectin Potato Starch Sulfamate

A 40% slurry of amylopectin potato starch is supplemented with 10% ammonium sulfamate (based on the starch). The reaction mixture is reacted by the gelatinizion of the starch. The paste product is subsequently drum-dried.

### Example 3

### Variants for the Preparation of Amylopectin Potato Starch Soluble in Cold Water

The preparation of a derivatized amylopectin potato starch soluble in cold water may be accomplished in various ways. Two typical process variants are given as examples.

A) Drum-Drying

Depending on the quality and viscosity desired of the cold water soluble end product, two method variants suggest themselves. Either the slurry of the cationic starch is dried directly on the drum, or the starch is initially gelatinized and drum-dried only subsequently. Both products are scaly.

B) Extrusion

By this method, the derivatized starch is converted into a cold water soluble product under the influence of mechanical forces and temperature in the presence of a small amount of water, the dry substance of the reaction mixture in the extruder usually being 70 to 90%. The starch obtained is present in granular form.

### Example 4

### Viscosity Development

The viscosity development is an experimental setup to describe the dissolution rate of a cold water soluble cationic starch.

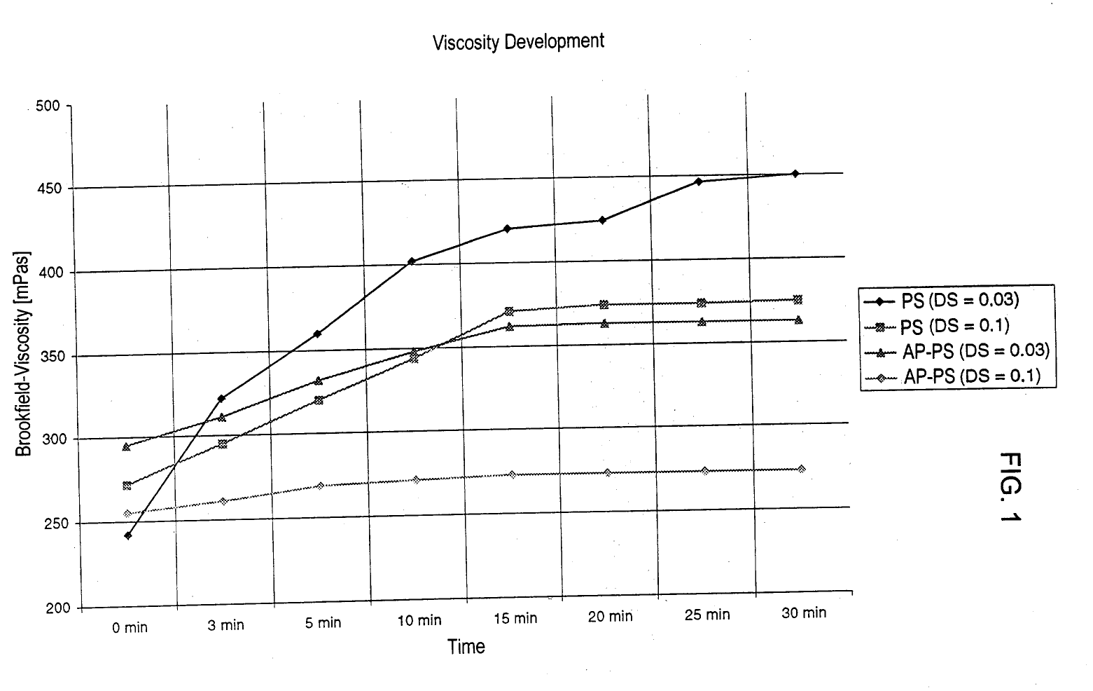

To this end, 4.5% cationic starches were stirred in at 1000 rpm for 3 minutes. The results are illustrated in FIG. 1

The curves clearly indicate that amylopectin potato starch derivatives have completed their viscosity development much earlier than conventional potato starch products. The tests, in particular, also revealed that amylopectin potato starch was clearly superior to conventional potato starch already at a low degree of substitution of 0.03, which advantage could be compensated for by conventional potato starch only through a higher nitrogen substitution.

### Example 5

### Structural Analytics of Amylopectin Potato Starch

In order to characterize the amylopectin potato starch, both the mean molecular weight and the molar mass distribution were determined. Both analytical methods are extensively described in the literature such as, for instance, by Chi-san Wu in Handbook of Size Exclusion Chromatography; Chromatographic Science Series, Vol. 69 (1995), Marcel Dekker Inc., New York.

In order to more clearly characterize the amylopectin potato starch, the amylopectin of a conventional potato starch was obtained by enrichment for comparative purposes. A number of methods are available for this method step, the present assay having been based on the fractionation according to the method described by J. Potze in “Starch Production Technology”, Chapter 14, pp 257-271. This method entails the heating of the starch to 155° C. and the selective precipitation of amylopectin by the aid of magnesium sulfate.

For the comparative representation of the mean molecular weight, also the measuring values of two conventional starches, namely waxy corn starch and conventional potato starch, were determined.

TABLE 1
Comparative Representation of Different Cooking
Starches

| | AP-PS | PS | WCS | FAP-PS |
|---|---|---|---|---|
| Mean molecular | 190.10⁶ | 48.10⁶ | 64.10⁶ | 43.10⁶ |
| weight | | | | |

PS = potato starch
AP-PS = amylopectin potato starch
WCS = waxy corn starch
FAP-PS = amylopectin-rich potato starch obtained by fractionation

From the above comparison, it is readily apparent that amylopectin potato starch (AP-PS) clearly distinguishes itself from other starches. There is a pronounced difference between amylopectin potato starch and fractionated amylopectin potato starch (FAP-PS) prepared by chemical/physical methods.

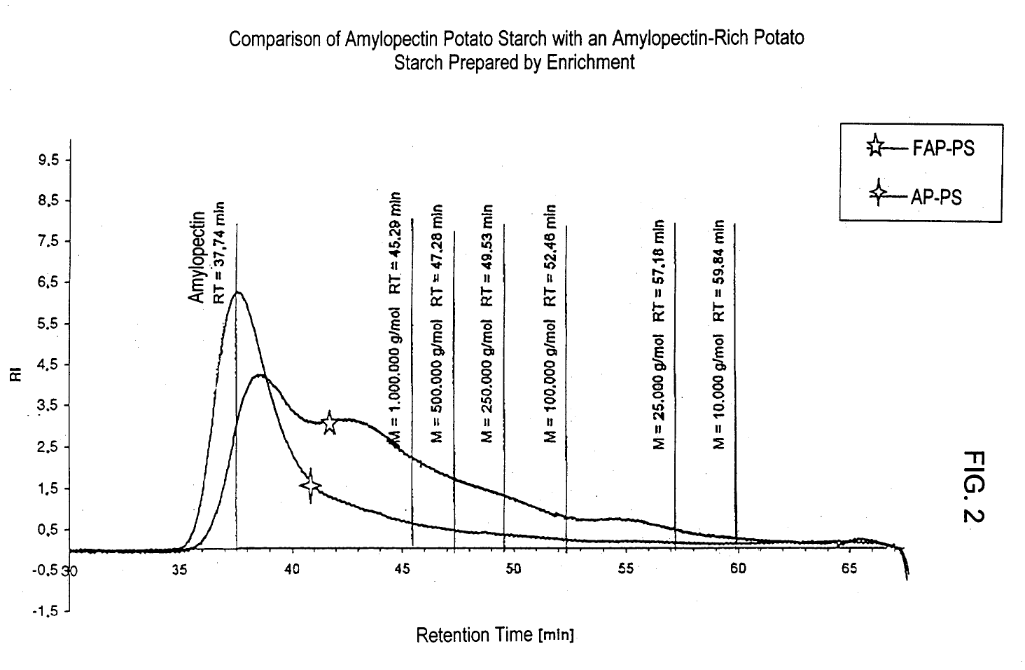

In order to more clearly depict the differences between amylopectin potato starch (AP-PS) and fractionated amylopectin potato starch (FAP-PS), also the molar mass distribution was determined through size exclusion chromatography. In addition, the surface ratio of the measured distribution was characterized (cf. FIG. 2).

| Retention time | AP-PS | FAP-PS |
|---|---|---|
| >41 min | 69.0% | 34% |
| <41 min | 31.0% | 66% |

While amylopectin potato starch (AP-PS) exhibits a significantly uniform molar distribution, fractionated amylopectin potato starch shows a much obscurer picture. What is, above all, typical is the portion of molar masses at a retention time of <41 minutes. With amylopectin potato starch, this is twice as large as with fractionated amylopectin potato starch. Due to the separation process involved in fractionation, the starch was degraded whereby also the properties of the products were changed.

### Example 6

### Comparative Analytical Characterization of Amylopectin Potato Starch (AP-PS) in View of Waxy Corn Starch (WCS), Corn Starch (CS), and Conventional Potato Starch (PS)

The values indicated in the Table below were taken from “Starch—Chemistry and Technology” by Roy L. Whistler et al., (1965), Academic Press, and supplemented with in-house experimental values.

| | MS | PS | WCS | AP-PS |
|---|---|---|---|---|
| % Amylose | 26-31 | 23-27 | <2 | <2 |
| % Lipid | 0.5-0.9 | 0-0.1 | 0.5-0.9 | 0-0.1 |
| % Protein | 0.2-0.4 | 0.05-0.2 | 0.1-0.35 | 0.05-0.2 |
| % | 0.01-0.02 | 0.04-0.13* | 0-0.02 | 0.04-0.15* |
| Phosphorus | | | | |

*defined as phosphate monoester

From the comparative representation of some specific analytical data, the differences between amylopectin potato starch (AP-PS) and the three conventional starches are clearly apparent. Compared to waxy corn starch and corn starch, amylopectin potato starch contains slighter amounts of lipids and proteins, whereas the high portion of naturally bound phosphate is very typical. The difference from conventional potato starch is reflected by the content of amylose. Due to the fact that amylopectin potato starch contains up to 100% amylopectin, its viscosity, for instance, or also the turbidity behavior of pastes, differ strongly. Thus, it was found that amylopectin potato starch exhibits a constant paste clarity even over an extended period of time, while conventional starches show noticeable turbidities. It is exactly on an industrial scale that the stability of starch or starch derivatives is of relevance to the quality of flocculation and the production of green bodies.

### Example 7

### Dissolution Behavior of Starch Sulfamates and Cationic Starches

An important characteristic of cold water soluble starches is their dissolution behavior. The manufacture of ceramics products calls for an unrestrictedly complete solubility without involving the formation of, for instance, agglomerations or lumps. In order to be able to examine the solubility of cold water soluble derivatized starches at all, the following experimental array was chosen, which is very similar to real life.

A container was filled with 15 L water under stirring at 700 rpm, and 15 g starch are rapidly admixed within a few seconds. The paste is stirred at room temperature for 3 minutes under the conditions indicated and subsequently filtered over an 800 m sieve. Paste residues on the stirrer as well as sieve residues were subjectively assessed to evaluate solubility. The following results were obtained:

TABLE 2
Cationic starches

| | Production | | Sieve | |
|---|---|---|---|---|
| | process* | DS** | residues | Paste on stirrer |
| commercial PS | WATRO | 0.03 | +/− | +/− |
| commercial PS | WATRO | 0.1 | +/− | − |
| AP-PS | WATRO | 0.03 | + | + |
| AP-PS | WATRO | 0.1 | + | + |
| WCS | WATRO | 0.03 | − | +/− |
| WCS | WATRO | 0.1 | − | +/− |
| FAP-PS | WATRO | 0.03 | +/− | +/− |
| FAP-PS | WATRO | 0.1 | +/− | − |
| PS | extruded | 0.03 | +/− | +/− |
| PS | extruded | 0.1 | +/− | − |
| AP-PS | extruded | 0.03 | + | + |
| AP-PS | extruded | 0.1 | + | + |

Starch sulfamates

| | | Sieve | |
|---|---|---|---|
| | Production process* | residues | Paste on stirrer |
| Commercial PS | WATRO | +/− | +/− |
| AP-PS | WATRO | + | + |
| WCS | WATRO | − | +/− |
| FAP-PS | WATRO | +/− | − |

*process used for the production of the cold water soluble starch derivative, cf. Example 3
**degree of substitution (DS)
PS = potato starch
AP-PS = amylopectin potato starch
WCS = waxy corn starch
FAP-PS = amylopectin-rich potato starch obtained by fractionation
Explanations in respect to the Table:
+ no paste residues on stirrer shaft, no sieve residues
+/− stirrer shaft slightly pasted up, sieve shows paste film and/or a few agglomerates
− stirrer shaft strongly pasted up, sieve shows many agglomerates and clots.

The dissolution tests clearly demonstrated that the amylopectin potato starch derivatives exhibited a solubility far better than that of conventional derivatives of potato starch, waxy corn starch or fractionated amylopectin potato starch obtained by enrichment. Comparative studies, furthermore, revealed that cationic products of amylopectin potato starch were clearly superior to conventional commercial products, which is again of great advantage in the manufacture of ceramics products.

### Example 8

### Ceramics Production

To a slurry of 210 g aluminum silicate fibers of the Kaowool brand and 25 L water are added 90 g of a filler like, for instance, mullite. Then, 13 g of a cold water soluble cationic amylopectin potato starch (DS=0.03) are introduced. Within a short period of time, the starch is dissolved and distributed in the system to the optimum degree. The optimum flock size and flock distribution could, in fact, be obtained by the addition of this starch. After this, 96 g of a commercially available 40% silica sol are added, briefly stirred, and subsequently the flock mass is sucked off via a screened mold upon application of vacuum. The shaped body is dried at about 120° C. and baked at about 1800° C.

In order to elucidate the advantages of the use of amylopectin potato starch, comparative tests were carried out with conventional cold water soluble cationic starches. In the course of these tests, the flocculation time, the turbidity of the circulating water after 20 passes as well as the physical parameters of the ceramics end product were determined.

TABLE 3

| | | | |
|---|---|---|---|
| PS ** | WCS | AP-PS | FAP-PS |

Measurements during production

| | | | | |
|---|---|---|---|---|
| Flocculation | 3 min | ^{3.5 min} | 2 min | 3 min |
| time | | | | |
| Turbidity * | 19 FTU | 12 FTU | 4 FTU | 11 FTU |

Analytics of ceramics end products

| | | | | |
|---|---|---|---|---|
| Density | 350 m³/kg | 372 m³/kg | 410 m³/kg | 347 m³/kg |
| Shrinkage | 2.0% | 2.4% | 0.9% | 1.9% |

* The turbidity, which had been caused by the presence of undissolved substances, was determined according to DIN EN 27027. Measurements were carried out by using Lange LTP 5 turbidimeters, calibration was effected by the aid of formazin standard suspensions, results are indicated in FTU (formazine turbidity units).
** The cationic potato starch used here corresponds to commercially available products as described, for instance, in international patent application WO 99/15322.

The measurements carried out with amylopectin potato starch revealed significantly reduced flocculation times as against conventional starches; moreover, the flocculation stability was considerably higher. The latter is reflected, in particular, by the clear reaction water, which is still clear and free of turbid matter even after 20 production passes. The enhanced processability of the ceramics products obtained by the use of amylopectin potato starch is apparent from the analytical data of the end products. The density of the products was significantly higher when using amylopectin potato starch, the shrinkage of the three-dimensional body was clearly reduced.

We claim:

1. A flocculant or binder composition for producing ceramic products, comprising amylopectin potato starch (AP-PS).

2. The flocculant or binder composition according to claim 1, wherein said AP-PS is modified.

3. The flocculant or binder composition according to claim 2, wherein said AP-PS is cationically modified AP-PS.

4. The flocculant or binder composition according to claim 2, wherein said AP-PS is modified with nitrogen-containing groups.

5. The flocculant or binder composition according to claim 4, wherein said AP-PS is modified with electropositively charged quaternary ammonium groups.

6. The flocculant or binder composition according to claim 1, wherein said AP-PS is AP-PS sulfamate.

7. The flocculant or binder composition according to claim 1, wherein said AP-PS is obtained from a potato modified by breeding for amylose inhibition.

8. The flocculant or binder composition according to claim 1, wherein said AP-PS is obtained from a potato modified by a molecular-biological technique for amylose inhibition.

9. The flocculant or binder composition according to claim 1, wherein said AP-PS is obtained from a potato modified by a genetic-engineering technique for amylose inhibition.

10. The flocculant or binder composition according to claim 1, wherein said AP-PS is obtained from a potato inhibited by antisense inhibition of a GBSS gene for amylose formation.

11. The flocculant or binder composition according to claim 1, wherein said AP-PS is obtained from a potato inhibited by cosuppression of amylose formation.

12. The flocculant or binder composition according to claim 1, wherein said AP-PS has an amylopectin content of at least 95% by weight.

13. The flocculant or binder composition according to claim 12, wherein said AP-PS has an amylopectin content of at least 98% by weight.

14. The flocculant or binder composition according to claim 1, wherein said AP-PS is contained as a swelling starch.

15. The flocculant or binder composition according to claim 1, wherein said AP-PS is at least 90% soluble in water at 25° C.

16. The flocculant or binder composition according to claim 15, wherein said AP-PS is at least 95% soluble in water at 25° C.

17. The flocculant or binder composition according to claim 16, wherein said AP-PS is at least 99% soluble in water at 25° C.

18. The flocculant or binder composition according to claim 1, wherein said AP-PS is physically degraded.

19. The flocculant or binder composition according to claim 1, wherein said AP-PS is thermally degraded.

20. The flocculant or binder composition according to claim 1, wherein said AP-PS is mechanically degraded.

21. The flocculant or binder composition according to claim 1, wherein said AP-PS is chemically degraded.

22. The flocculant or binder composition according to claim 1, wherein said AP-PS is thermochemically degraded

23. The flocculant or binder composition according to claim 21, wherein said AP-PS is chemically degraded by oxidation.

24. The flocculant or binder composition according to claim 21, wherein said AP-PS is chemically degraded by acid.

25. The flocculant or binder composition according to claim 1, wherein said AP-PS is etherified.

26. The flocculant or binder composition according to claim 1, wherein said AP-PS is an ether selected from the group consisting of a methyl, ethyl, hydroxyl, hydroxypropyl, hydroxybutyl, carboxymethyl, cyanoethyl, and carbamoyl ether.

27. The flocculant or binder composition according to claim 1, wherein said AP-PS is in an esterified form.

28. The flocculant or binder composition according to claim 1, wherein:
said AP-PS includes an ester having an ester residue RCOO—; and
said ester residue R is a residue selected from the group consisting of an alkyl, aryl, alkenyl, alkaryl, and aralkyl residues, having from 1 to 17 carbon atoms.

29. The flocculant or binder composition according to claim 28, wherein said ester residue R has from 1 to 6 carbon atoms.

30. The flocculant or binder composition according to claim 29, wherein said ester residue R has from 1 to 2 carbon atoms.

31. The flocculant or binder composition according to claim 1, wherein said AP-PS includes an acid ester selected from the group consisting of acetic, propionic, butyric, stearic, phthalic, succinic, oleic, maleic, fumaric, and benzoic acid ester.

32. The flocculant or binder composition according to claim 1, wherein said AP-PS is crosslinked.

33. The flocculant or binder composition according to claim 1, wherein said AP-PS is crosslinked with a crosslinker selected from the group consisting of epichlorohydrin and 1,3-dichloro-2-propanol.

34. The flocculant or binder composition according to claim 33, wherein said crosslinker is mixed with (poly)amines.

35. The flocculant or binder composition according to claim 1, wherein said AP-PS is crosslinked by reaction with an aldehyde-releasing reagent.

36. The flocculant or binder composition according to claim 35, wherein said aldehyde-releasing reagent is selected from the group consisting of N,N′-dimethylol-N,N′-ethyleneurea with phosphoroxychloride, sodium trimetaphosphate, di-epoxide, polyepoxide, mixed anhydrides of carbonic acids with at least one of di- and tribasic acids, glyoxal, and aldehydes.

37. The flocculant or binder composition according to claim 36, wherein said mixed anhydrides of carbonic acids with at least one of di- and tribasic acids are adipic acid/Ac₂O.

38. The flocculant or binder composition according to claim 36, wherein said aldehydes are selected from the group consisting of formic, acetic, and propionic aldehyde.

39. The flocculant or binder composition according to claim 1, wherein said AP-PS is modified ionically by including a group selected from the a cationic and an anionic group.

40. The flocculant or binder composition according to claim 1, wherein said AP-PS is a starch graft polymer.

41. The flocculant or binder composition according to claim 1, wherein said AP-PS is a starch graft copolymer.

42. The flocculant or binder composition according to claim 40, wherein said AP-PS graft polymer is an emulsion polymer.

43. The flocculant or binder composition according to claim 41, wherein said AP-PS graft copolymer is an emulsion polymer.

44. The flocculant or binder composition according to claim 1, wherein said AP-PS has a degree of substitution from 0.00001 to 3.

45. The flocculant or binder composition according to claim 44, wherein said AP-PS has a degree of substitution from 0.001 to 2.

46. The flocculant or binder composition according to claim 45, wherein said AP-PS has a degree of substitution from 0.005 to 1.

47. The flocculant or binder composition according to claim 1, wherein said AP-PS is esterified by an acid.

48. The flocculent or binder composition according to claim 47, wherein said acid is inorganic.

49. The flocculant or binder composition according to claim 47, wherein said acid is organic.

50. The flocculant or binder composition according to claim 47, wherein said acid is heterovalent.

51. The flocculant or binder composition according to claim 50, wherein said acid is bivalent.

52. The flocculant or binder composition according to claim 47, wherein said acid is in a salt form.

53. The flocculant or binder composition according to claim 47, wherein said acid is in an ester form.

54. The flocculent or binder composition according to claim 47, wherein said is in an anhydride form.

55. The flocculant or binder composition according to claim 47, wherein said acid is selected from the group consisting of o-phosphoric acid, m-phosphoric acid, poly-phosphoric acid, sulfuric acid, silicic acid, boric acids, oxalic acid, succinic acid, glutaric acid, adipic acid, phthalic acid, and citric acid.

56. The flocculant or binder composition according to claim 1, wherein said AP-PS is etherified by an—substituted acid.

57. The flocculant or binder composition according to claim 56, wherein said—substituted acid is in a salt form.

58. The flocculant or binder composition according to claim 56, wherein said—substituted acid is in an ester form.

59. The flocculant or binder composition according to claim 56, wherein said—substituted acid is in an anhydride form.

60. The flocculant or binder composition according to claim 56, wherein said—substituted acid is inorganic.

61. The flocculant or binder composition according to claim 56, wherein said—substituted acid is organic.

62. The flocculant or binder composition according to claim 56, wherein said—substituted acid is selected from the group consisting of—halocarbonic acid, chlorohydroxy alkyl sulfonate, and chlorohydroxy alkyl phosphonate.

63. The flocculant or binder composition according to claim 1, wherein said AP-PS is cationically modified by a substituent selected from the group consisting of an amino, imino, ammonium, sulfonium, and phosphonium group.

64. The flocculant or binder composition according to claim 1, wherein said AP-PS is cationically modified by a nitrogen-containing group.

65. The flocculant or binder composition according to claim 64, wherein said nitrogen-containing group is selected from the group consisting of a primary, secondary, tertiary, and quaternary amine.

66. The flocculant or binder composition according to claim 1, wherein said AP-PS includes an electropositively charged quaternary ammonium group.

67. The flocculant or binder composition according to claim 1, wherein said AP-PS is in a plurality of derivatives forming a mixture.

68. The flocculant or binder composition according to claim 1, further comprising an additive selected from the group consisting of a sedimentation accelerator, stabilizer, dispersant, antifoaming agent, softener, non-starch-based adhesive, non-starch-based adhesive precursor, buffer salt, and preserving agent.

69. A method for producing ceramics, which comprises using AP-PS as a flocculant.

70. A method for producing ceramics, which comprises using AP-PS as a binder.

71. A method for producing ceramics, which comprises using the flocculant or binder composition according to claim 1.

72. A slurry for producing ceramics, comprising a flocculant or binder according to claim 1.

73. The slurry according to claim 72, wherein said AP-PS has a concentration from 0.001 to 0.5 weight percent.

74. The slurry according to claim 72, further comprising additives selected from the group consisting of an inorganic fiber, filler, organic material, and inorganic binder.

75. The slurry according to claim 74, wherein said inorganic fiber is based on an aluminum silicate.

76. The slurry according to claim 74, wherein said filler is an oxide selected from the group consisting of an oxide of aluminum, aluminum silicate, and chalk.

77. The slurry according to claim 74, wherein said organic material is an organic fiber selected from the group consisting of cellulose and polyethylene.

78. The slurry according to claim 74, wherein said inorganic binder is colloidal silica.

79. A method for producing a ceramics product, which comprises the following steps:
preparing the slurry according to claim 72; and
thermally treating the slurry at a temperature above 300° C.

80. The method according to claim 79, wherein the temperature is above 500° C.

81. The method according to claim 79, wherein the slurry is prepared by:
providing an aqueous suspension of inorganic fibers; and
adding an inorganic binder and the flocculant or binder according to claim 1.

82. The method according to claim 81, wherein the inorganic binder is silica sol.

83. The method according to claim 81, which further comprises adding additives and fillers with the flocculant or binder.

84. The method according to claim 79, which further comprises, before the thermally treating step, drying the slurry at a temperature from 100 to 200° C.

85. The method according to claim 84, wherein the temperature of the drying step is from 120 to 140° C.

86. The method according to claim 79, wherein the thermally treating step includes sintering.

87. The method according to claim 79, wherein the thermally treating step has a maximum temperature from 800 to 2500° C.

88. The method according to claim 87, wherein the maximum temperature is from 1500 to 2000° C.

89. The method according to claim 88, wherein the maximum temperature is 1800° C.

90. The method according to claim 79, which further comprises mechanically removing water from the slurry before the thermally treating step.

91. The method according to claim 84, which further comprises mechanically removing water from the slurry before the drying step.

92. The method according to claim 79, which further comprises forming the slurry before the thermally treating step.

93. The method according to claims 79, wherein the thermally treating step includes penetrating into the slurry a liquid selected from the group consisting of a liquid metal and a liquid metal alloy.

94. A ceramic product obtainable by a method according to claim 79.
